(19) United States
(12) Patent Application Publication
(10) Pub. No.: US 2010/0109992 A1
(43) Pub. Date: May 6, 2010

(54) ACTIVE MATRIX DISPLAY DEVICES AND DISPLAY METHODS THEREOF

(75) Inventors: Naoki SUMI, Hyogo (JP); Minoru SHIBAZAKI, Hyogo (JP); Masahiro YOSHIGA, Hyogo (JP)

Correspondence Address: LOWE HAUPTMAN HAM & BERNER, LLP, 1700 DIAGONAL ROAD, SUITE 300, ALEXANDRIA, VA, 22314, US

(73) Assignee: TPO Displays Corp., Chu-Nan (TW)

(21) Appl. No.: 12/582,433

(22) Filed: Oct. 20, 2009

(30) Foreign Application Priority Data
Oct. 31, 2008 (JP) 2008-281423

(51) Int. Cl. G09G 3/36

(52) U.S. Cl. 345/89

(57) ABSTRACT

An active matrix display device having pixels disposed in a matrix is provided. Each pixel is divided into sub-pixels with different areas. The display device includes an inputting portion, multi-bit memories, digital-to-analog conversion circuits, display elements, and a conversion portion. The inputting portion inputs image digital data from outside of the active matrix display device. The multi-bit memories are disposed respectively for the sub-pixels and store input digital data with at least two bits, which serves as gray level information for gray-scale displaying of the sub-pixels. The digital-to-analog conversion circuits convert the input digital data to analog data which is used for the gray-scale displaying. The display elements perform the gray-scale displaying according to the analog data. The conversion portion converts the image digital data to the input digital data according to a predetermined gamma value waiting to be achieved and an area ratio of the sub-pixels.

### CROSS REFERENCE TO RELATED APPLICATIONS

This application claims the benefit of Japan application Serial No. JP2008-281423 filed Oct. 31, 2008, the subject matter of which is incorporated herein by reference.

### BACKGROUND

1. Technical Field

The invention relates to an active matrix display device whose pixel matrix is divided into sub-pixels, and more particularly to an active matrix display device and display method for the active matrix display device, wherein a multi-bits memory is disposed for each sub-pixel for performing gray-scale displaying of middle tones smoothly.

2. Description of the Related Art

It has been known that an active matrix liquid crystal display device is composed of a plurality of pixels disposed in a matrix. In conventional liquid crystal display devices, a pixel is divided into a plurality of sub-pixels, and black color or white color is displayed in the sub-pixels with different areas. Through the combination of the areas of the sub-pixels, the gradient gray-scale displaying can be performed (referring to Japan Patent Publication NO. 2005-300579).

However, in conventional liquid crystal display devices (referred as prior arts in the following), since each sub-pixel displays only black color or white color (1 bit), it restrains middle tones between black color and white color from smoothly displaying. For example, when a displayed image of a liquid crystal display device is enlarged, we can watch undesired dot images which appear in the middle tones between black color and white color.

### SUMMARY

Thus, the inventor of the application had provided an active matrix display device (referred as a conventional display device in the following) where a multi-bit memory and a digital-to-analog converter are disposed for each sub-pixel to enhance the aperture ratio and display middle tones between black color and white color smoothly.

In the conventional display device, as shown in FIG. 12, each of a plurality of pixels 70 is divided into a low-bit sub-pixel 71a, a middle-bit sub-pixel 71b, and a high-bit sub-pixel 71c. The area ratio of the sub-pixels 71a, 71b, and 71c is 1:4:16. A multi-bit memory for storing 2-bit digital input data and a digital-to-analog converter for converting the digital input data to analog data used for displaying are disposed for each of the sub-pixels 71a, 71b, and 71c. A liquid crystal display element of each sub-pixel performs gray-scale displaying according to the gray level corresponding to the analog data.

As shown in FIG. 13, each sub-pixel can perform gray-scale displaying with four gray levels from 0 to 3. At this time, the brightness of each sub-pixel varies in linearity according to the gray level variation. For example, referring to FIG. 13, in the case of that the corresponding brightness of the sub-pixel is set as “0” when the gray level thereof the sub-pixel is “0” and the corresponding brightness of the sub-pixel is set as “1” when the gray level thereof is “3”, the corresponding brightness of the sub-pixel is set as “1/3” when the gray level thereof is “1” and the corresponding brightness of the sub-pixel is set as “2/3” when the gray level thereof is “2”.

Thus, through the combination of the different brightness represented by the sub-pixels 71a, 71b, and 71c, each pixel 70 can performs gray-scale displaying by sixty-four gray levels from 0 to 63 which are represented by 6-bit binary values “000000”˜“111111”.

The conventional display device can perform gray-scale displaying of the sub-pixels by various gray levels corresponding to the analog data which is used for displaying. In other words, compared with the prior arts in which one sub-pixel only displays black color or white color, since one sub-pixel of the conventional display device can display various middle tones, the conventional display device can perform the same or better multi-level gray-scale displaying as or than the prior arts by using the less number of the sub-pixels than the prior arts. Moreover, since the conventional display device can decrease the number of the sub-pixels composing one pixel, the structure boundary area (optics inactive area) between the sub-pixels is reduced, thereby enhancing the aperture ratio of the pixels. Further, compared with the prior arts, the conventional display device can smoothly display middle tones since each sub-pixel can display various middle tones.

In the conventional display device as shown in FIG. 13, since the brightness of each sub-pixel varies in linearity according to the gray level variation, the displaying gamma value is equal to 1. Accordingly, input image data whose gamma value is set at a value except 1, such as 2.2, can not be displayed in the predetermined fashion, but the input image data is displayed by a whitish with white color instead. Thus, there is still much room for improvement.

Further, in order to deal with the cases whose gamma value is set at a value except 1, the input image data can be converted in advance according to the desired gamma characteristic. However, since the memory bit number of the multi-bit memory is less to be equal to 2, deep black areas can not be displayed clearly due to black shift resulted from rounding error in the case of simple data conversion.

Thus, the invention provides an active matrix display device and a display method for the active matrix display device, which can easily accomplish a gamma characteristic with any gamma values, thereby improving the conventional display device.

An exemplary embodiment of an active matrix display device has a plurality of pixels disposed in a matrix. Each of the pixels is divided into a plurality of sub-pixels with different areas. The active matrix display device comprises an inputting portion, a plurality of multi-bit memories, a plurality of digital-to-analog conversion circuits, a plurality of display elements, and a conversion portion. The inputting portion inputs image digital data from outside of the active matrix display device. The multi-bit memories are disposed respectively for the sub-pixels and store input digital data with at least two bits. The input digital data serves as gray level information for gray-scale displaying of the sub-pixels. The digital-to-analog conversion circuits convert the input digital data stored in the multi-bit memories to analog data which is used for the gray-scale displaying of the sub-pixels. The display elements perform the gray-scale displaying of the sub-pixels according to the analog data converted by the digital-to-analog conversion circuits. The conversion portion converts the image digital data from the inputting portion to the input digital data according to a predetermined gamma value waiting to be achieved and an area ratio of the sub-pixels.

In the active matrix display device, the conversion portion converts the image digital data from the inputting portion to the input digital data according to the predetermined gamma value waiting to be achieved and the area ratio of the sub-pixels. Thus, each sub-pixel can perform displaying of middle tones and displays the middle tones smoothly, thereby achieving the desired gamma characteristic.

In the active matrix display device, the conversion portion comprises at least one lookup table showing relationship between the image digital data and the input digital data according to the predetermined gamma value and the area ratio of the sub-pixels.

In the active matrix display device, at least one lookup table is used to show relationship between the image digital data and the input digital data according to the predetermined gamma value and the area ratio of the sub-pixels, thereby converting the image digital data to the input digital data. Thus, the conversion process becomes easy. Moreover, when the desired gamma value is changed, the used lookup table is adjusted according to the variation, thereby easily performing the corresponding process in response to the variation of the gamma.

In the active matrix display device, the conversion portion comprises two or more than two lookup tables, and the conversion portion further comprises a selection portion for selecting one of the lookup tables according to a result of dither process applied to the image digital data.

In the active matrix display device, the lookup table to be used is selected according to the result of dither process applied to the image digital data. Thus, the gray-scale displaying with a smooth gamma characteristic can be achieved.

In the active matrix display device, each of the pixels is divided into n sub-pixels, an area ratio of the n sub-pixels is set as 1:2: . . . :2ⁿ⁻¹, n is an integer larger than 2.

In the active matrix display device, the area ratio of the n divided sub-pixels is set as 1:2: . . . :2ⁿ⁻¹. Thus, the area of each sub-pixel is not too small, even if the sub-pixel is the smallest one. The manufacture of the sub-pixels is not difficult.

In the active matrix display device, a shape of each of the sub-pixels is symmetrical to a pixel center of the sub-pixels, and each of the sub-pixels is disposed in a position symmetrical to the pixel center.

In the active matrix display device, each of the sub-pixels has a shape symmetrical to a pixel center of the sub-pixels and is disposed in a position symmetrical to the pixel center. The gravity center of the sub-pixels is prevented from shifting, thereby restraining bar-type distortion resulted from the shifting of the gravity center of the sub-pixels.

An exemplary embodiment of a display method is applied for an active matrix display device having a plurality of pixels disposed in a matrix. Each of the pixels is divided into a plurality of sub-pixels with different areas. The display method comprises: for each of the sub-pixels, storing input digital data with more then two bits, wherein the input digital data serves as gray level information for gray-scale displaying of the sub-pixels; converting the stored input digital data to analog data which is used for the gray-scale displaying of the sub-pixels; performing the gray-scale displaying of the sub-pixels according to a gray level corresponding the converted analog data; and converting an image digital data which is externally input to the stored input digital data according to a predetermined gamma value waiting to be achieved and an area ratio of the sub-pixels.

In the display method, the image digital data which is externally input is converted to the stored input digital data according to the predetermined gamma value waiting to be achieved and the area ratio of the sub-pixels. Thus, in the active matrix display device, each sub-pixel can perform displaying of middle tones and displays the middle tones smoothly, thereby achieving the desired gamma characteristic.

The display further comprises a step of setting relationship between an area ratio of the sub-pixel and brightness ratio which the sub-pixels are capable to display according to a characteristic of a gamma value waiting to be achieved.

In the display method, the relationship between the area ratio of the sub-pixel and the brightness which the sub-pixels are capable to display is optimized according to a characteristic of the gamma value waiting to be achieved. Thus, in the active matrix display device, each sub-pixel can perform displaying of middle tones and displays the middle tones smoothly, thereby achieving the desired gamma characteristic.

An exemplary embodiment of a display method is applied for an active matrix display device having a plurality of pixels disposed in a matrix. Each of the pixels is divided into a plurality of sub-pixels with different areas. The display method comprises: for each of the sub-pixels, storing input digital data with more then two bits to serve as gray level information for gray-scale displaying of the sub-pixels; converting the stored input digital data to analog data which is used for the gray-scale displaying of the sub-pixels; performing the gray-scale displaying of the sub-pixels according to a gray level corresponding to the converted analog data; and setting brightness which the sub-pixels are capable to display according to a characteristic of a gamma value waiting to be achieved, which is larger than 1, by satisfying conditions. The conditions are comprises: each of the sub-pixel performs the gray-scale displaying by m gray levels 0˜(m−1), and in the case of that the corresponding relative brightness of the sub-pixel is 0 when the gray level of the sub-pixel is 0 and the corresponding brightness of the sub-pixel is 1 when the gray level of the sub-pixel is m−1, the corresponding brightness of the sub-pixel is less than t/(m−1) when the gray level of the sub-pixel is t, and 1≦t≦m−2.

In the display method, the brightness which the sub-pixels are capable to display is set according to the characteristic of the gamma value waiting to be achieved, which is larger than 1, by the above satisfying conditions. Thus, in the active matrix display device, each sub-pixel can perform displaying of middle tones and displays the middle tones smoothly, thereby achieving the characteristic of the gamma value larger than 1.

In the embodiment, the image digital data is converted to the input digital data stored in the multi-bit memories according to the predetermined gamma value waiting to be achieved and the area ratio of the sub-pixels. Thus, in structure, each sub-pixel has a multi-bit memory in the active matrix display device to achieve the desired characteristic of the gamma value.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view showing an exemplary embodiment of a liquid crystal display device;

FIG. 2 is a block diagram of the conversion portion;

FIG. 3 is a block diagram of the display circuit;

FIG. 4 shows an exemplary circuit of the display circuit;

FIG. 5 shows the bit distribution of the sub-pixels in a conventional display device;

FIG. 6 shows the bit distribution of the sub-pixels in the embodiment of the liquid crystal display device;

FIG. 7 shows the relationship between the brightness and gray level of the pixel in the embodiment of the liquid crystal display device;

FIG. 8 shows the relationship between the area ratio of the sub-pixels and the brightness ratio of the sub-pixels when the liquid crystal display device of the embodiment achieves the objective of that the gamma value is equal to 1 in the embodiment of the liquid crystal display device;

FIG. 9 shows the relationship between the area ratio of the sub-pixels and the brightness ratio of each sub-pixel in a conventional display device;

FIG. 10 shows the relationships between the area ratio of the sub-pixels and the brightness ratio of each sub-pixel for various gamma values in the embodiment of the liquid crystal display device;

FIG. 11 shows the relationship between the gray level and the brightness of the sub-pixel to achieve the gamma value larger than 1 in the embodiment of the liquid crystal display device;

FIG. 12 a schematic view showing one pixel divided into a plurality of sub-pixels in a conventional display device; and

FIG. 13 shows the relationship between the gray level and the brightness of the sub-pixel in a conventional display device.

### DETAILED DESCRIPTION

An active matrix display device of the invention will be described according to the drawings. In the embodiment, a liquid crystal display device used for an electronic device, such as a cellular phone, a digital camera, a personal digital assistant (PDA), a personal computer, a television, an automotive display, an aviation display, a digital photo frame, and a portable DVD player, is given as example for description. The liquid crystal display device is implemented as an active matrix display device with plurality of pixel disposed in a matrix.

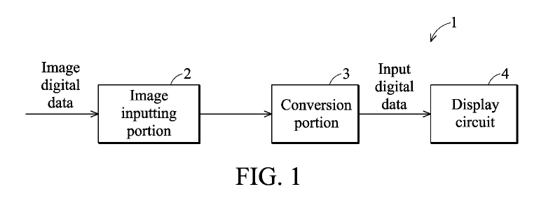

FIG. 1 is a schematic view showing an exemplary embodiment of a liquid crystal display device. The liquid crystal display device 1 comprises an image inputting portion 2 for receiving image digital data which is input from the outside of the liquid crystal display device and is prepared to be displayed, a conversion portion 3 for converting the received image digital data to input digital data which stores in multi-bit memories described latter, and a display circuit 4.

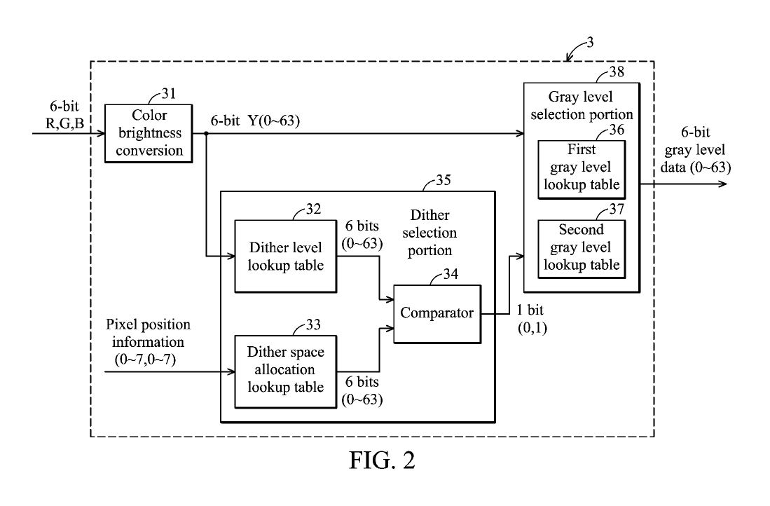

FIG. 2 is a block diagram of the conversion portion 3. The conversion portion 3 comprises a color brightness conversion portion 31, a dither selection portion 35, and a gray level selection portion 38. The dither selection portion 35 comprises a dither level lookup table 32, a dither space allocation lookup table 33, and a comparator 34. The gray-level selection portion 38 comprises a first gray level lookup table 36 and a second gray-level lookup table 37.

The color brightness conversion portion 31 converts the R, G, B color image data with 6 bits from the image inputting portion 2 to brightness data Y with 6 bits (0˜63). The converted brightness data is output to the dither level lookup table 32 and the gray level selection portion 38.

The dither level lookup table 32 stores pattern dither threshold values which are set according to a gamma value waiting to be achieved for gray levels 0˜63. The dither level lookup table 32 further outputs 6-bit data (0˜63) corresponding to the level of the brightness data from the color brightness conversion portion 31 to the comparator 34. The dither space allocation lookup table 33 stores an 8×8 dither matrix and outputs 6-bit data corresponding to position information (X and Y coordinates information) of the target pixel to the comparator 34.

In the embodiment, an 8×8 dither matrix is given as an example, and, however, the size of the dither matrix can be random, such as a 2×2 dither matrix. In the case of the 2×2 dither matrix, each of the dither levels stored in the dither level lookup table 32 and the dither space allocation lookup table 33 is 2 bits (0˜3). Moreover, in the embodiment, a pattern dither is given as an example, and, however, random dither or combination of various matters of the dither space position lookup table can be used.

The comparator 34 compares the data from the dither level lookup table 32 with the data from the dither space allocation lookup table 33. The comparison result has 1 bit and is output to the gray level selection portion 38. Concretely, when the data from the dither level lookup table 32 is less than the data from the dither space allocation lookup table 33, the comparator 34 output a comparison signal “0” to the gray level selection portion 38, and when the data from the dither level lookup table 32 is greater than the data from the dither space allocation lookup table 33, the comparator 34 output a comparison signal “1” to the gray level selection portion 38.

The first gray level lookup table 36 and the second gray level lookup table 37 of the gray level selection portion 38 store data distribution of the brightness data from the color brightness conversion portion 31 for each of the multi-bit memories. In other words, the lookup tables 36 and 37 store gray level data which should to be stored in each of the multi-bit memories according to the gamma value waiting to be achieved for each level of the brightness data. Moreover, the first gray level lookup table 36 is a lookup table for the low level (in the case when the comparison signal from the comparator 34 is “0”), while the second gray level lookup table 37 is a lookup table for the high level (in the case when the comparison signal from the comparator 34 is “1”). According to the brightness data from the color brightness conversion 31 and the comparison signal from the comparator 34, the gray level selection portion 38 provides 6-bit data (0˜63) representing the gray level waiting to be displayed. The provided 6-bit data serves as the input digital data input to the multi-bit memories and is output to the display circuit 4.

Moreover, the values stored in the dither level lookup table 32, the dither space allocation lookup table 33, the first gray level lookup table 36, and the second gray level lookup table 37 are set according to the gamma value waiting to be achieved and the area ratio of the three sub-pixel described latter.

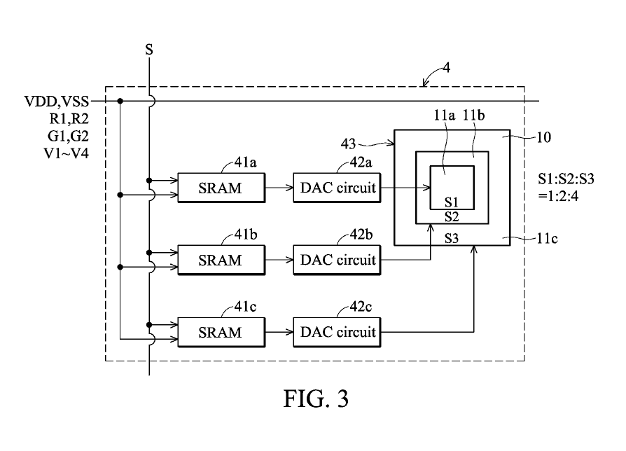

FIG. 3 is a block diagram of the display circuit 4. As shown in FIG. 3, in the liquid crystal display device of the embodiment, each of the pixels 10 are divided into three sub-pixels 11a, 11b, and 11c. The display circuit 4 comprises static random access memories (SRAMs) 41a, 41b, and 41c which serve as the multi-bit memories and are disposed respectively for the sub-pixels 11a, 11b, and 11c. The display circuit 4 further comprises digital-to-analog conversion (DAC) circuits 42a, 42b, and 42c which are disposed respectively for the sub-pixels 11a, 11b, and 11c and liquid crystal display elements 43 for performing gray-scale displaying in the sub-pixels 11a, 11b, and 11c.

As shown in FIG. 3, the periphery shape of the sub-pixel 11a is square. The sub-pixel 11b surrounds the sub-pixel 11a, and the periphery shape of the sub-pixel 11b is square. The sub-pixel 11c surrounds the sub-pixel 11b, and the periphery shape of the sub-pixel 11c is square. The area ratio S1:S2:S3 of these three sub-pixels 11a, 11b, and 11c is set as 1:2:4.

Each of the SRAMs 41a, 41b, and 41c for the sub-pixels 11a, 11b, and 11c stores 2-bit input digital data from source lines, for example, “00”, “01”, “10”, and “11”. In the following, it will describe that four-level gray-scale displaying can be performed in the sub-pixels 11a, 11b, and 11c according to the input digital data.

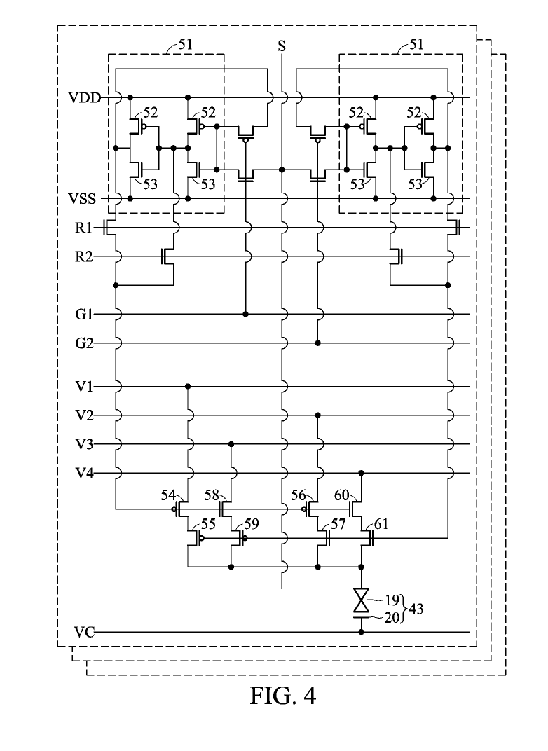

The DAC circuits 42a, 42b, and 42c of the sub-pixels 11a, 11b, and 11c convert the input digital data stored in the corresponding SRAMs 41a, 41b, and 41c to analog data which is used for gray-scale displaying in the respective sub-pixels 11a, 11b, and 11c. Concretely, each of the DAC circuits 42a, 42b, and 42c is used to convert the 2-bit input digital data to four analog voltage values V1, V2, V3, V4 which are applied to pixel electrodes 19 of the sub-pixels 11a, 11b, and 11c (referring to FIG. 4).

The liquid crystal display element 43 of each of the sub-pixels 11a, 11b, and 11c comprises a pixel electrode 19 and an opposite electrode 20 and performs gray-scale displaying by using the gray level corresponding to the analog data used for displaying. In the embodiment, the liquid crystal display elements 43 perform four-level gray-scale displaying according to the four voltage values V1, V2, V3, and V4 converted by the DAC circuits 42a, 42b, and 42c. Moreover, each of the liquid crystal displaying elements 43 further comprises a reflection portion (not shown in FIG. 4) for reflecting outside light. In other words, the liquid crystal displaying elements 43 are reflecting-type liquid crystal display elements.

In following, the structure of the display circuit 4 of the liquid crystal display device 1 will be described by referring to FIG. 4. FIG. 4 shows an exemplary circuit of the display circuit 4 of the liquid crystal displaying device 1. For clear description, FIG. 4 only shows the display circuit 4 used by one sub-pixel 11a among the three sub-pixels 11a, 11b, and 11c. The display circuits 4 used by the other sub-pixel 11b and 11c have the same structure as FIG. 4.

First, the SRAMs of the sub-pixel will be described. As shown in FIG. 4, the SRAMs are composed of two hold circuits 51. Each of the hold circuit 51 comprises two inverting circuits, each composed of a PMOS transistor 52 and an NMOS transistor 53 which are coupled in series. The two inverting circuits compose a positive feedback. Voltages VDD and VSS are applied to the hold circuits 51 for driving them. When a high voltage is applied to gate electrodes G1 and G2, the 2-bit input digital data is input from a source line S, and each hold circuit 51 keeps 1-bit data.

For example, when a high voltage is applied to the gate electrode G1, the high-bit data among the 2-bit input digital data (for example “1” among the 2-bit input digital data “10”) is kept by the first hold circuit 51 (the left hold circuit in FIG. 4). When a high voltage is applied to the gate electrode G2, the low-bit data among the 2-bit input digital data (for example “0” among the 2-bit input digital data “10”) is kept by the second hold circuit 51 (the right hold circuit in FIG. 4).

The DAC circuit is then described. As shown in FIG. 4, the DAC circuit comprises two PMOS transistors 54 and 55 coupled to a supplier line of the analog voltage V1, PMOS and NMOS transistors 56 and 57 coupled to a supplier line of the analog voltage V2, NMOS and PMOS transistors 58 and 59 coupled to a supplier line of the analog voltage V3, and two NMOS transistors 60 and 61 coupled to a supplier line of the analog voltage V4.

The gates of the PMOS transistors 54 and 55 coupled to the supplier line of the analog voltage V1 are coupled to the signals from the hold circuits 51, respectively. Thus, when the signal output from the two hold circuits 51 is “00” (the signal “0” from the first hold circuit, and the signal “0” from the second hold circuit), the PMOS transistors 54 and 55 are turned on, and the analog voltage V1 is provided to the pixel electrode 19. The gates of the PMOS and NMOS transistors 56 and 57 coupled to the supplier line of the analog voltage V2 are coupled to the signals from the hold circuits 51, respectively. Thus, when the signal output from the two hold circuits 51 is “01”, the PMOS and NMOS transistors 56 and 57 are turned on, and the analog voltage V2 is provided to the pixel electrode 19.

The gates of the NMOS and PMOS transistors 58 and 59 coupled to the supplier line of the analog voltage V3 are coupled to the signals from the hold circuits 51, respectively. Thus, when the signal output from the two hold circuits 51 is “10”, the NMOS and PMOS transistors 58 and 59 are turned on, and the analog voltage V3 is provided to the pixel electrode 19. Moreover, the gates of the NMOS transistors 60 and 61 coupled to the supplier line of the analog voltage V4 are coupled to the signals from the hold circuits 51, respectively. Thus, when the signal output from the two hold circuits 51 is “11”, the NMOS transistors 60 and 61 are turned on, and the analog voltage V4 is provided to the pixel electrode 19.

Then, the refresh operation of the liquid crystal display element 43 is described. As shown in FIG. 4, two signal lines are disposed in each hold circuit 51 for outputting the digital data at the two inverting circuits. In other words, one signal line is disposed for outputting the original state of the input digital data, and the other signal line is disposed for outputting the inverse state of the input digital data. When a high voltage is applied to a refresh line R1, the data with the original state of the input digital data (such as “1”) is output (such as “1”). Oppositely, when a high voltage is applied to a refresh line R2, the data with the inverse state of the input digital data (such as “1”) is output (such as “0”). Thus, by alternatively applying a high voltage to the refresh lines R1 and R2, the signals output from the two hold circuits 51 are inverse, so that the analog voltages V1, V2, V3, and V4 applied to the pixel electrode 19 can be inverse. The refresh operation of the liquid crystal element 43 can be performed by synchronizing the switching of applying the voltage VC to the opposite electrode 20 and the switching of applying a high level to the refresh lines R1 and R2.

In the following, the operation of the liquid crystal display device 1 will be described. The 6-bit R, G, B, color image data input from the image inputting portion 2 is converted to the 6-bit brightness data Y in the color brightness conversion portion 31. The converted brightness data is then output to the dither level lookup table 32 and the gray level selection portion 38.

In the comparator 34, the 6-bit data (0˜63) which corresponds to the level of the brightness data and is read from the dither level lookup table 32 is compared with the 6-bit data (0˜63) which corresponds to the position information of the target pixel and is read from the dither space allocation lookup table 33. Then, when the data from the dither level lookup table 32 is less than the data from the dither space allocation lookup table 33, the comparator 34 output the comparison signal “0” to the gray level selection portion 38; when the data from the dither level lookup table 32 is greater than the data from the dither space allocation lookup table 33, the comparator 34 output the comparison signal “1” to the gray level selection portion 38.

When the comparison signal “0” is input to the gray level selection portion 38, the 6-bit data (0˜63) which represents the gray levels stored in the SRAMs 41a, 41b, and 41c is read from the first gray-scale lookup table 36 according to the level of the brightness data and output to the display circuit 4. Oppositely, when the comparison signal “1” is input to the gray level selection portion 38, the 6-bit data (0˜63) which represents the gray levels stored in the SRAMs 41a, 41b, and 41c is read from the second gray-scale lookup table 37 according to the level of the brightness data level and output to the display circuit 4.

The 6-bit digital data (0˜63) which represents the gray levels stored in the SRAMs 41a, 41b, and 41c (each SRAM corresponds to two bits) is converted to the analog data which is used for gray-scale displaying in the respective sub-pixels 11a, 11b, and 11c. Then, the voltages corresponding to the analog data used for gray-scale displaying are applied to the liquid crystal display elements 43.

Thus, through the combination with different brightness of the three sub-pixels 11a, 11b, and 11c, each pixel 10 can performs gray-scale displaying by sixty-four gray levels from 0 to 63 which are represented by 6-bit binary values “000000”˜“111111”.

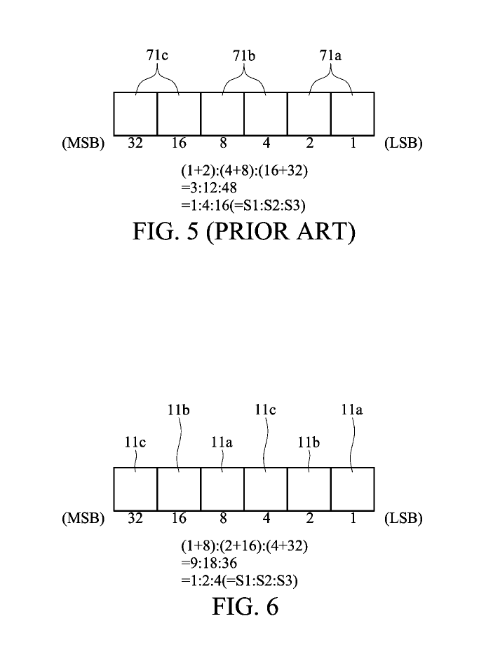

In the following, the manner of distributing six bits to the sub-pixels 11a, 11b, and 11c will be described. In the convention display device provided by the inventor of the application, referring to FIG. 5, two low bits among the six bits are distributed to the sub-pixel 71a, two middle bits among the six bits are distributed to the sub-pixel 71b, and two high bits among the six bits are distributed to the sub-pixel 71c. Thus, the area ratio S1:S2:S3 of the sub-pixels 71a, 71b, and 71c is 1:4:16.

However, in the display device of the embodiment, referring to FIG. 6, the two bits comprising the lowest bit and the third bit counted from the highest bit are distributed to the sub-pixel 11a, the two bits comprising the second bit counted from the lowest bit and the second bit counted from the highest bit are distributed to the sub-pixel 11b, and the two bits comprising the third bit counted from the lowest bit and the highest bit are distributed to the sub-pixel 11c. Thus, the area ratio S1:S2:S3 of the sub-pixels 11a, 11b, and 11c is 1:2:4.

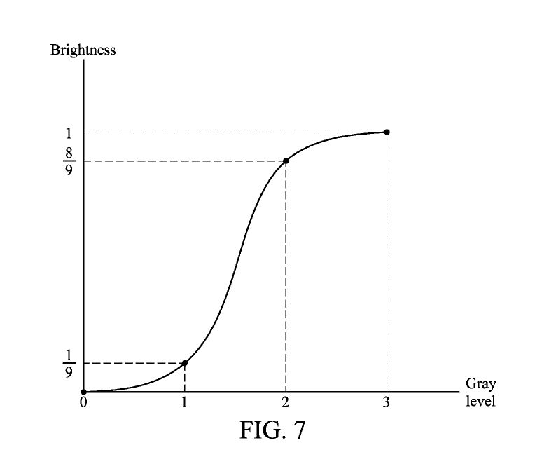

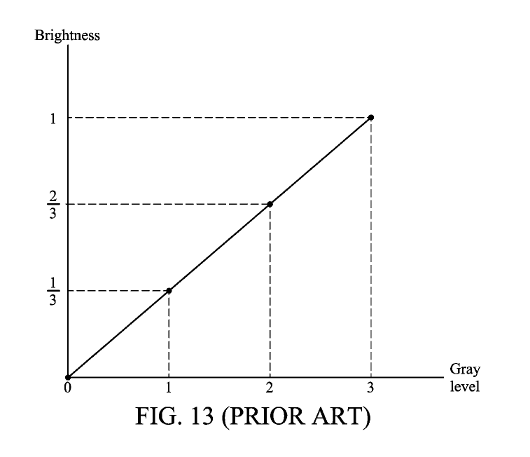

Accordingly, in the conventional displaying device, as shown in FIG. 13, variation of the brightness of each pixel to the gray levels is linear. Oppositely, according to the display device of the application, as shown in FIG. 7, in the case of that the corresponding brightness of the sub-pixel is set as “0” when the gray level thereof is “0” (“00”) and the corresponding brightness of the sub-pixel is set as “1” when the gray level thereof the sub-pixel is “3” (“11”), the corresponding brightness of the sub-pixel is set as “1/9” when the gray level thereof the sub-pixel is “1” (“01”) and the corresponding brightness of the sub-pixel is set as “8/9” when the gray level thereof is “2” (“10”). The condition in which the gamma value is equal to 1 is correctly achieved.

The same improvement of the liquid crystal device of the embodiment and the conventional display device is that by disposing a multi-bit memory and a digital-to-analog conversion circuit for each sub-pixel, the aperture ratio is increased and the middle tones can be displayed smoothly even if the number of the sub-pixels is less than the prior arts.

Moreover, in the case in which it is desired to display a high gamma value, an input image digital data is converted to an input digital data which is stored in a multi-bit memory according to a gamma value to be achieved and a area ratio of sub-pixels, and the brightness ratio of the sub-pixels is optimized in advance, so that the desired characteristic of the gamma value can be achieved. Accordingly, the problem of that image are correctly displayed only when the gamma value is equal to 1 in the conventional display device can be solved, and the liquid crystal device of the embodiment can be applied for other gamma values.

Since lookup tables (first gray level lookup table 36 and second gray level lookup table 37) are used, it is easy to proceed a process of that an image digital data input from outside is converted to an input digital data which is stored in a multi-bit memory. When the desired gamma value is changed, it is better to correspondingly adjust the lookup tables, so that the changing of the gamma value can be processed easily.

Moreover, the dither selection portion 35 is used to perform pattern dither process to the image digital data, and the lookup table which should be used is selected according to the processed result. Thus, the smoother characteristic of the gamma value can be achieved.

In the embodiment, the area ratio of the three divided sub-pixel is set as 1:2:4. Compared with the area ratio 1:4:16 in the conventional display device, the area of the smallest sub-pixel is not too little, so that the high technique is not required to fabricate the sub-pixels, and the manufacture of the sub-pixels is not difficult.

In the embodiment, since the shapes and the allocation of the three sub-pixels 11a, 11b, and 11c are symmetrical to the center of the pixels 10, the gravity center of the sub-pixels 11a, 11b, and 11c is prevented from shifting, thereby restraining bar-type distortion resulted from the shifting of the gravity center of the sub-pixels 11a, 11b, and 11c.

In the embodiment, since the SRAMs 41a, 41b, and 41c are implemented to serve as the multi-bit memories for the sub-pixels 11a, 11b, and 11c, power consumption of the memories can be reduced. Moreover, by disposing the memories for the pixels 10, the input digital data stored in the memories can be used to drive the sub-pixels 11a, 11b, and 11c, and power consumption of external devices (such as chips) used by the liquid crystal display device can be reduced in the case of displaying standby images.

In the embodiment, since the light reflected from the reflection portion is used for displaying, power consumption can be reduced significantly compared with usage of backlight units.

In the embodiment, one pixel composed of three sub-pixels is given an example, however, without limitation. The number of the sub-pixels composing one pixel can be equal to two, equal to four, or more than four. For example, in the case in which two sub-pixels compose one pixel, the area ratio of these sub-pixels is 1:2; in the case in which four sub-pixels compose one pixel, the area ratio of these sub-pixels is 1:2:4:8. Generally, in the case in which n sub-pixels compose one pixel, the area ratio of these sub-pixels is 1:2: . . . :2ⁿ⁻¹.

In the embodiment, the multi-memory of each sub-pixel which stores 2-bit input digital data is given as an example, however, without limitation. The input digital data stored in the multi-memory of each sub-pixel can be equal to three or more than three.

An exemplary embodiment described in the following can achieve the desired gamma characteristic and optimizes the relationship between the area ratio of the sub-pixels and the brightness ratio of the sub-pixels.

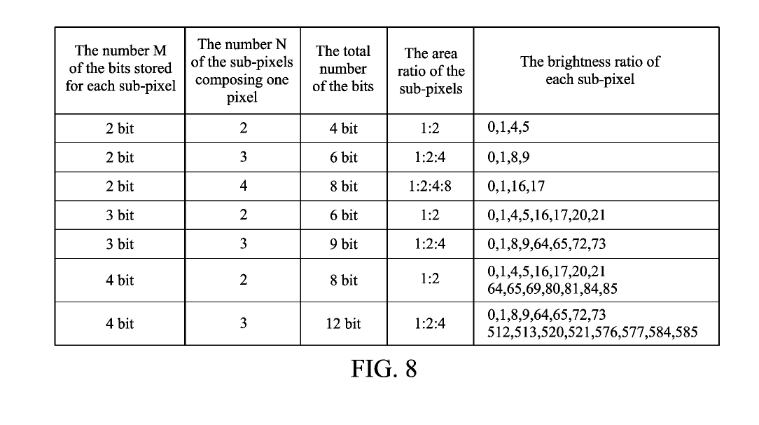

FIG. 8 shows the relationship between the area ratio of the sub-pixels and the brightness ratio of the sub-pixels when the liquid crystal display device of the embodiment achieves the objective of that the gamma value is equal to 1. FIG. 8 indicates the number (M:M≧2) of the bits stored for each sub-pixel, the number (N:N≧2) of the sub-pixels composing one pixel, the total number (M×N) of the stored bits, the area ratio of the sub-pixels, and the brightness ratio of each sub-pixel.

In the below equation (1), each term Aₓ of the area ratio of the sub-pixels is represented by 2^{x} (that is Aₓ=2^{x} (x=0, 1, . . . , N−1)), and the brightness of each sub-pixel is represent by Iₓ.

$${I}_{x} = {\sum }_{i = 0}^{M - 1} [ {2}^{iN} ⌊ \frac{x}{{2}^{i}} mod 2 ⌋ ] \\ ( x = 0 , 1 , … , {2}^{M} - 1 ) \qquad ( 1 )$$

In the embodiment, by satisfying the relationship between the area ratio of the sub-pixels and the brightness ratio of each sub-pixel of FIG. 8, the characteristic of the gamma value equal to 1 can be achieved.

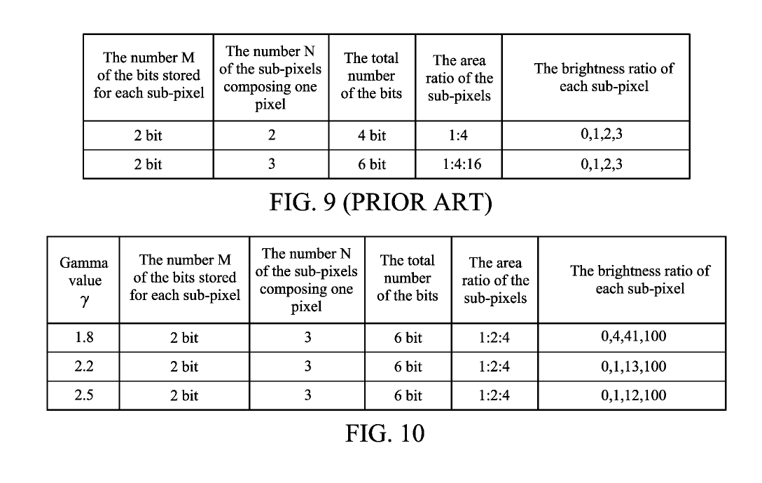

FIG. 9 shows the relationship between the area ratio of the sub-pixels and the brightness ratio of each sub-pixel in the conventional display device. The conventional display device only achieve the case of that the gamma value is equal to 1.

FIG. 10 shows the relationships between the area ratio of the sub-pixels and the brightness ratio of each sub-pixel for various gamma values (1.8, 2.2, 2.5). FIG. 10 shows the number (M:M≧2) of the bits stored for each sub-pixel, the number (N:N≧2) of the sub-pixels composing one pixel, the total number (M×N) of the stored bits, the area ratio of the sub-pixels, and the brightness ratio of each sub-pixel for each desired gamma value (γ). Similarly to FIG. 8, each term Aₓ of the area ratio of the sub-pixels is represented by 2^{x} (that is Aₓ=2^{x} (x=0, 1, . . . , N−1)).

In the embodiment, by satisfying the relationship between the area ratio of the sub-pixels and the brightness ratio of each sub-pixel of FIG. 10, the characteristics of various gamma values can be achieved.

In the embodiment, the values of the area ratio of the sub-pixels and the brightness ratio of each sub-pixel in FIG. 10 are given as an example, without limitation. Other values of the area ratio of the sub-pixels and the brightness ratio of each sub-pixel can be used to obtain the desired gamma values (expect for 1).

When the number of the bits stored for each sub-pixel is equal to 2, there are four levels for the brightness of each sub-pixel (the brightness from low to high is L₀, L₁, L₂, L₃). The levels of the brightness for large gamma values are L₀=0%, L₁≦5%, L₂≦50%, and L₃=100%.

For example, it is assumed that the input digital data is 6-bit gray level data, the dither process is for 64 levels, the area ratio of the sub-pixels is 1:2:4, and the desired gamma value is equal to 2.2. The brightness level L₁ has to be lower than 4.9%, to achieve smallest brightness difference (one level difference), as shown in equation (2).

L₁×1/64×1/(1+2+4)≦(1/63)^{2.2} (2)

Thus, L₁≦0.049(4.9%).

In the following, the setting of the brightness which the sub-pixel is capable to display will be described. Each sub-pixel can perform gray-scale displaying according to m gray levels (0˜(m−1)). In the case of that the corresponding relative brightness of the sub-pixel is “0” when the gray level thereof the sub-pixel is “0” and the corresponding relative brightness of the sub-pixel is “1” when the gray level thereof is “m−1”, the corresponding relative brightness of the sub-pixel is set to be less than “t/(m−1)” when the gray level thereof is “t” (1≦t≦m−2).

In the case of the gamma value γ=1.8 of FIG. 10, m is equal to 4 (m=4), and thus, each sub-pixel can perform gray-scale displaying according to four gray levels (0˜3). When the gray level of the sub-pixel is “0”, the corresponding relative brightness thereof is “0”, and when the gray level of the sub-pixel is “3”, the corresponding relative brightness thereof is “1” (obtained by normalizing “100” of FIG. 10). The corresponding relative brightness is “4/100” (obtained by normalizing “4” of FIG. 10) as t=1, and the corresponding relative brightness is “41/100” (obtained by normalizing “41” of FIG. 10) as t=2. At this time, the corresponding relative brightness “4/100” as t=1 is less than “1/3”, and the corresponding relative brightness “41/100” as t=2 is less than “2/3”.

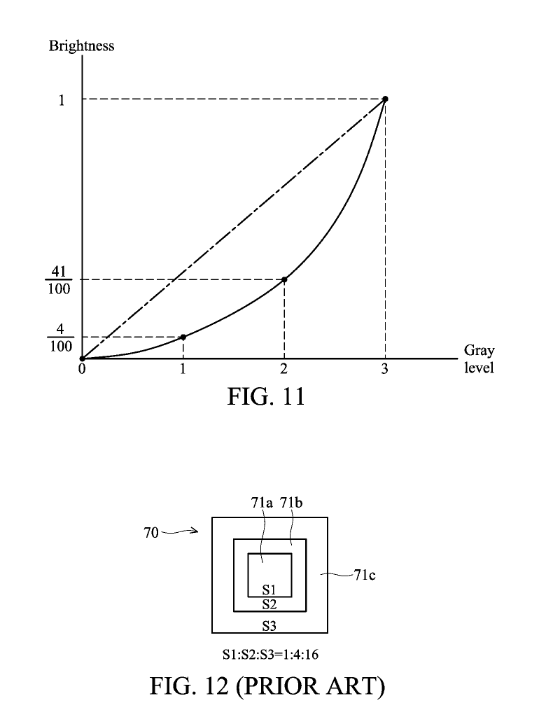

According to the above description, the relationship between the gray level and the brightness of the sub-pixel is shown in FIG. 11. In order to achieve the gamma value being larger than 1, the characteristics of the gray level/brightness is placed in the area below the direct line (represented by the dotted line in FIG. 11) to set the brightness of the sub-pixel.

Moreover, in the above embodiment, the case of the gamma value γ=1.8 is described, and however, the above operation and/or method can be also applied for the cases of the gamma value γ=2.2 and γ=2.5 in FIG. 10.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

For example, in the above embodiment, a liquid crystal display device is given as an example for an active matrix display device, however, without. The active matrix display device can be implemented by an organic electro-luminescence display device. Moreover, in the above embodiment, a normally black type liquid crystal display device (displaying a black image when the voltage is equal to 0) is given as an example, however, without. The liquid crystal display device can be normally white type.

In the above embodiment, an SRAM is given as an example for a multi-bit memory, however, without. The multi-bit memory can be implemented by a dynamic random access memory (DRAM), thereby decreasing the size of the memory circuit.

What is claimed is:

1. An active matrix display device having a plurality of pixels disposed in a matrix, and each of the pixels divided into a plurality of sub-pixels with different areas, comprising:
an inputting portion for inputting image digital data from outside of the active matrix display device;
a plurality of multi-bit memories, disposed respectively for the sub-pixels, for storing input digital data with at least two bits, wherein the input digital data serves as gray level information for gray-scale displaying of the sub-pixels;
a plurality of digital-to-analog conversion circuits for converting the input digital data stored in the multi-bit memories to analog data which is used for the gray-scale displaying of the sub-pixels;
a plurality of display elements for performing the gray-scale displaying of the sub-pixels according to the analog data converted by the digital-to-analog conversion circuits; and
a conversion portion for converting the image digital data from the inputting portion to the input digital data according to a predetermined gamma value waiting to be achieved and an area ratio of the sub-pixels.

2. The active matrix display device as claimed in claim 1, wherein the conversion portion comprises at least one lookup table showing relationship between the image digital data and the input digital data according to the predetermined gamma value and the area ratio of the sub-pixels.

3. The active matrix display device as claimed in claim 2, wherein the conversion portion comprises two or more than two lookup tables, and the conversion portion further comprises a selection portion for selecting one of the lookup tables according to a result of dither process applied to the image digital data.

4. The active matrix display device as claimed in claim 1, wherein each of the pixels is divided into n sub-pixels, an area ratio of the n sub-pixels is set as 1:2: . . . :2ⁿ⁻¹, n is an integer larger than 2.

5. The active matrix display device as claimed in claim 1, wherein a shape of each of the sub-pixels is symmetrical to a pixel center of the sub-pixels, and each of the sub-pixels is disposed in a position symmetrical to the pixel center.

6. A display method for an active matrix display device having a plurality of pixels disposed in a matrix, and each of the pixels divided into a plurality of sub-pixels with different areas, comprising:
for each of the sub-pixels, storing input digital data with more then two bits, wherein the input digital data serves as gray level information for gray-scale displaying of the sub-pixels;
converting the stored input digital data to analog data which is used for the gray-scale displaying of the sub-pixels;
performing the gray-scale displaying of the sub-pixels according to a gray level corresponding the converted analog data; and
converting an image digital data which is externally input to the stored input digital data according to a predetermined gamma value waiting to be achieved and an area ratio of the sub-pixels.

7. The display method as claimed in claim 6 further comprising setting relationship between an area ratio of the sub-pixel and brightness ratio which the sub-pixels are capable to display according to a characteristic of a gamma value waiting to be achieved.

8. A display method for an active matrix display device having a plurality of pixels disposed in a matrix, and each of the pixels divided into a plurality of sub-pixels with different areas, comprising:
for each of the sub-pixels, storing input digital data with more then two bits, wherein the input digital data serves as gray level information for gray-scale displaying of the sub-pixels;
converting the stored input digital data to analog data which is used for the gray-scale displaying of the sub-pixels;
performing the gray-scale displaying of the sub-pixels according to a gray level corresponding to the converted analog data; and
setting brightness which the sub-pixels are capable to display according to a characteristic of a gamma value waiting to be achieved, which is larger than 1, by satisfying conditions;
wherein the conditions are comprises: each of the sub-pixel performs the gray-scale displaying by m gray levels 0˜(m−1), and in the case of that the corresponding relative brightness of the sub-pixel is 0 when the gray level of the sub-pixel is 0 and the corresponding brightness of the sub-pixel is 1 when the gray level of the sub-pixel is m−1, the corresponding brightness of the sub-pixel is less than t/(m−1) when the gray level of the sub-pixel is t, and 1≦t≦m−2.
